(19) United States
(12) Patent Application Publication
(10) Pub. No.: US 2025/0157243 A1
(43) Pub. Date: May 15, 2025

(54) SYSTEMS AND METHODS FOR DOCUMENT PROCESSING

(71) Applicant: Optum, Inc., Minnetonka, MN (US)

(72) Inventors: Prakhar MISHRA, Gurgaon (IN); Rajesh SABAPATHY, Gurgaon (IN); Atul SINGH, Bangalore (IN); Kunal SURI, Greater Noida (IN); Saumajit SAHA, Bangalore (IN)

(21) Appl. No.: 18/505,683

(22) Filed: Nov. 9, 2023

(51) Int. Cl. G06V 30/416; G06F 40/106; G06F 40/114; G06V 30/414

(52) U.S. Cl. CPC G06V 30/416; G06F 40/106; G06F 40/114; G06V 30/414

(57) ABSTRACT

Systems and methods are disclosed processing a document. A method includes receiving, by a processor coupled to a memory, layout information for two or more layouts of a document, each layout of the two or more layouts having a layout bounding box. The method includes identifying, by the processor, one or more areas of overlap between the layout bounding boxes of each layout, respectively. The method includes identifying, by the processor, content associated with each area of overlap. Further, the method may include use the layout information, the areas of overlap, and the identified content associated with each area of overlap as inputs to a machine learning model. Further, the method may include receiving, by the processor from the machine-learning model, a layout bounding box configuration for one or more of the layouts of the document. Further, the method may include apply the layout bounding box configuration to the document.

### TECHNICAL FIELD

Various embodiments of this disclosure relate generally to techniques for document processing, and more specifically, to systems and methods for enhanced recognition, standardization, and extraction of information from one or more documents.

### BACKGROUND

Document processing and Optical Character Recognition (OCR) technologies have emerged as vital tools in numerous industries, including the healthcare sector. These technologies promise to automate the extraction of information from documents, thereby streamlining workflow, reducing manual effort, and enhancing data accessibility and utility. Despite the significant advancements, current document processing and OCR methods face substantial challenges that often result in sub-optimal performance, especially when extracting information from complex documents such as medical reports.

One of the primary inadequacies of existing methods lies in their understanding and interpretation of the layout and structure of a document. Many conventional OCR systems primarily focus on the recognition of individual characters and words, often neglecting the overall document structure and layout. This approach tends to overlook the significance of spatial relationships, formatting elements, and visual hierarchies that provide context to the document's contents. Consequently, these systems may misinterpret the role and relevance of different text sections, leading to errors in data extraction and comprehension.

For instance, current methods may struggle to associate sections of text with one another correctly. They may fail to discern that a heading relates to a subsequent paragraph, or that a caption is associated with a specific table or image. Similarly, they may not identify nested or hierarchical structures, such as bulleted lists or multi-level headings, which frequently carry information about the document's organization and content relationships.

The consequence of these shortcomings is particularly pronounced in the medical field, which frequently relies on the accurate and efficient extraction of information from medical documents. Medical documents, such as patient records, test results, diagnostic reports, and research papers, often feature complex structures, specialized language, and varied layouts. They may contain multiple sections, tables, images, lists, and references, all of which need to be correctly interpreted and associated to understand the document comprehensively.

The performance of an OCR system is largely contingent upon the technical proficiency of the underlying computing architecture. If there are deficiencies in this architecture, such as inefficient data processing or insufficient memory allocation, the OCR system could produce erroneous or incomplete results. For example, a subpar text recognition algorithm might fail to correctly identify and associate text with a corresponding document, such as a medical chart. This could result in a misrepresentation of the data. Moreover, if the system struggles to accurately process tabulated data, like medication schedules due to a lack of computational resources, it could misinterpret information, potentially leading to incorrect dosing recommendations or flawed medication regimens.

Therefore, there is a need for improved document processing and OCR methods that can adequately understand and interpret document layouts and structures. Such methods should accurately associate sections and/or layouts of text with one another, facilitating the comprehensive, accurate, and efficient extraction of information from complex documents, particularly in fields such as healthcare.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

The present disclosure solves the problems described above or elsewhere in the present disclosure and improves the state of conventional healthcare applications. The present disclosure teaches systems and methods for document processing.

In some aspects, the techniques described herein relate to a computer-implemented method for resolving conflicts in document layout, the method including: receiving, by a processor coupled to a memory, layout information for two or more layouts of a document, each layout of the two or more layouts having a layout bounding box; identifying, by the processor, one or more areas of overlap between the layout bounding boxes of the two or more layouts, respectively; identifying, by the processor, content associated with each area of overlap, the content including stylometric features; determining, by the processor and based at least on the layout information for the document, the one or more areas of overlap, and the content associated with each area of overlap, a layout bounding box configuration for the two or more of the layouts of the document; and applying, by the processor, the layout bounding box configuration to the document.

In some aspects, the techniques described herein relate to a system for resolving conflicts in document layout, the system including: a memory storing instructions; and a processor executing the instructions to perform a process including: receiving layout information for two or more layouts of a document, each layout of the two or more layouts having a layout bounding box; identifying one or more areas of overlap between the layout bounding boxes of the two or more layouts, respectively; identifying content associated with each area of overlap, the content include stylometric features; determining, based at least on the layout information for the document, the one or more areas of overlap, and the content associated with each one or more area of overlap, a layout bounding box configuration for the two or more of the layouts of the document; and applying the layout bounding box configuration to the document.

In some aspects, the techniques described herein relate to a computer-implemented method for processing a document, the method including: receiving, by a processor coupled to a memory, a document; determining, by the processor, section information for the document, the section information including one or more sections, each of the one or more sections including a section bounding box; determining, by the processor, layout information for the document, the layout information including one or more layouts, each of the one or more layouts including a layout bounding box; identifying, by the processor, one or more areas of overlap between one or more layout bounding boxes; identifying, by the processor, content associated with each of the one or more areas of overlap; determining, by the processor, based at least on the layout information for the document, the one or more areas of overlap, and the content associated with each of the one or more areas of overlap, a layout bounding box configuration for the one or more of the layouts of the document; applying the layout bounding box configuration to the document, thereby creating one or more adjusted layout bounding boxes; identifying, by the processor, one or more conflicts, each conflict including a bounding box associated with a first layout overlapping with both a first section bounding box and a second section bounding box, the bounding box associated with the first layout including a layout bounding box or an adjusted layout bounding box; determining, by the processor, an area of overlap between the first layout and the first section bounding box and an area of overlap between the first layout and the second section bounding box; assigning, by the processor, the first layout to a section based on the area of overlap between the first layout and the first section bounding box and the area of overlap between the first layout and the second section bounding box; and adjusting, by the processor, the bounding box associated with the first layout based on a section bounding box associated with the assigned section.

It is to be understood that both the foregoing general description and the following detailed description are example and explanatory only and are not restrictive of the detailed embodiments, as claimed.

### BRIEF DESCRIPTION OF THE DRAWINGS

The accompanying drawings, which are incorporated in and constitute a part of this specification, illustrate various example embodiments and together with the description, serve to explain the principles of the disclosed embodiments.

FIG. 1 is a diagram showing an example of a system that is capable of document processing, according to some embodiments of the disclosure.

FIG. 2a is a diagram of example components of a document processing platform, according to some embodiments of the disclosure.

FIG. 2b is a diagram of example components of a section identification module, according to some embodiments of the disclosure.

FIG. 2c is a diagram of example components of a layout detection module, according to some embodiments of the disclosure.

FIG. 2d is a diagram of example components of a relation finder module, according to some embodiments of the disclosure.

FIG. 2e is a diagram of example components of a structure standardization module, according to some embodiments of the disclosure.

FIG. 3 is a flowchart showing a method for processing a document, according to some embodiments of the disclosure.

FIG. 4 is a flowchart showing a method for processing a document, according to some embodiments of the disclosure.

FIG. 5 shows an example machine-learning training flow chart, according to some embodiments of the disclosure.

FIG. 6 illustrates an implementation of a computer system that executes techniques presented herein, according to some embodiments of the disclosure.

### DETAILED DESCRIPTION

Various embodiments of this disclosure relate generally to techniques for text prediction, and, more particularly, to systems and methods for processing a document by resolving section and layout conflicts to output higher quality and more accurate optical character recognition data.

As previously discussed, despite advancements in document processing and optical character recognition techniques, conventional methods still face certain limitations and challenges. One of these challenges involves adequately understanding the layout and structure of complex documents, particularly when elements such as tables, lists, and images are involved. The intricacies of spatial relationships and visual hierarchy can often lead to errors and inaccuracies in the extracted information. Furthermore, the complex and resource-intensive nature of traditional OCR techniques can result in significant computational power and memory requirements. Additionally, these traditional approaches often lack the capability to handle variations and anomalies in real-world documents, leading to suboptimal performance and poor accuracy rates.

In view of the limitations of conventional methodologies, the techniques disclosed herein aim to substantially enhance the ability to process, understand, and extract information from documents, with particular effectiveness in the context of complex medical documents. By utilizing a unique combination of modules and machine-learning models to identify and standardize structures, detect layouts, and resolve conflicts, the disclosed system and method have the potential to vastly improve the accuracy and efficiency of information extraction. The systems and methods disclosed herein are adapted to effectively consider the intricacies of the document's structure and layout, thereby improving the extraction of pertinent information. The systems and methods disclosed herein are not only capable of managing generalized data sets but also exhibits robust performance with varied and unseen data. By generating output in a variety of formats that are suitable for different use cases in the medical field, the system becomes significantly more versatile, further expanding its applicability and value.

The system and methods disclosed herein demonstrate significant technical improvements over the prior art. A comparison of different OCR methods was undertaken for Full Document OCR, Section OCR, and the present disclosure. These methods are evaluated based on three metrics: Precision, Recall, and the F1 score, which is a harmonic mean of precision and recall. Higher values in each of these metrics signify better performance.

Full Document OCR has the lowest precision, recall, and F1 scores, indicating it has the poorest overall performance of the three methods. With a precision of 50.03% and recall of 43.86%, it implies that this method correctly identifies just half of the relevant text present in a document, and almost half of its recognitions are actually incorrect.

Section OCR significantly improves on this, with a precision rate of 95.37%. This means that when the OCR recognizes a character or a section, it's likely to be correct. However, the recall rate is only 57.14%, meaning that this method fails to identify a significant portion of the relevant text in a document. Even though the system is highly accurate when it does identify something, it's missing a lot of potential identifications. This results in an F1 score of 67.43%, which, while better than Full Document OCR, still leaves room for improvement.

The present disclosure outperforms both Full Document OCR and Section OCR in all three metrics. It offers a high precision rate of 96.10%, demonstrating and improvement in accuracy when identifying a character or a section as being relevant. Additionally, the present disclosure also has a significantly higher recall rate of 71.50% compared to existing methods, showing that it's more effective at identifying all the relevant text in a document. This balance of high precision and high recall leads to a superior F1 score of 79.92%, which again represents a significant improvement over the prior art.

While principles of the present disclosure are described herein with reference to illustrative embodiments for particular applications, it should be understood that the disclosure is not limited thereto. Those having ordinary skill in the art and access to the teachings provided herein will recognize additional modifications, applications, embodiments, and substitution of equivalents all fall within the scope of the embodiments described herein. Accordingly, the invention is not to be considered as limited by the foregoing description.

Various non-limiting embodiments of the present disclosure will now be described to provide an overall understanding of the principles of the structure, function, and use of systems and methods disclosed herein for predicting a next text.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

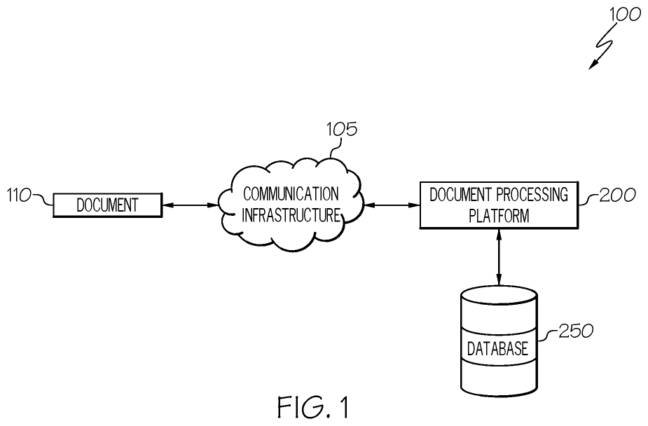

FIG. 1 is a diagram showing an example of a system that is capable of document processing, according to some embodiments of the disclosure. Looking at FIG. 1, a network environment for processing and analyzing one or more documents is represented, conforming to an embodiment of the present invention. The network environment 100 incorporates a communication infrastructure 105, a collection of one or more documents 110, a document processing platform 200, and a database (or data storage) 250.

In one embodiment, various components of the network environment 100 interact with each other through the communication infrastructure 105. The communication infrastructure 105 backs a range of different communication protocols and techniques. In one embodiment, the communication infrastructure 105 facilitates the document processing platform 200 to communicate with one or more other systems, including the collection of one or more documents 110, which in certain embodiments, is stored on a distinct platform and/or system. The communication infrastructure 105 of the network environment 100 includes one or more networks such as a data network, a wireless network, a telephony network, or any combination thereof. It is contemplated that the data network can be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network could be, for example, a cellular communication network and employs various technologies including 5G (5th Generation), 4G, 3G, 2G, Long Term Evolution (LTE), wireless fidelity (Wi-Fi), Bluetooth®, Internet Protocol (IP) data casting, satellite, mobile ad-hoc network (MANET), vehicle controller area network (CAN bus), and the like, or any combination thereof.

The collection of one or more documents 110, in some embodiments, consists of one or several documents, which can take various forms, such as text-based content, images, audio, or video, and can be stored in a variety of formats, such as plain text, PDF, HTML, XML, or other structured or unstructured data formats. In a preferred embodiment, the documents relate to the medical industry, such as documents which contain information related to medical treatment and diagnosis of patients. The collection of one or more documents 110 can be managed and stored on one or more devices within the network environment 100, such as local or remote file servers, cloud-based storage services, or other forms of data repositories.

The document processing platform 200 enables document structure identification techniques to be applied to the documents 110, utilizing various tools and resources such as the section identification module 210, layout detection module 220, and relation finder module 230. The document processing platform 200 can include various software applications, frameworks, or libraries that enable document structure identification techniques to be applied to the documents 110. These techniques can include tasks such as list detection, table detection, paragraph detection, and others.

In some embodiments, the document processing platform 200 is a platform with multiple interconnected modules. The document processing platform 200 includes one or more servers, intelligent networking devices, computing devices, components, and corresponding software for processing one or more documents 110. In addition, it is noted that the document processing platform 200 can be a separate entity of the system.

The database 250 is used to support the storage and retrieval of data related to the collection of one or more documents 110, storing metadata about the documents 110, such as author, date, and content type, as well as any extracted information from the document processing platform 200. The database 250 can consist of one or more systems, such as a relational database management system (RDBMS), a NoSQL database, or a graph database, depending on the requirements and use cases of the network environment 100.

In one embodiment, the database 250 is any type of database, such as relational, hierarchical, object-oriented, and/or the like, wherein data are organized in any suitable manner, including data tables or lookup tables. In one embodiment, the database 250 accesses or includes any suitable data that are utilized to identify document structure. In one embodiment, the database 250 stores content associated with one or more system and/or platform, such as the document processing platform 200 and manages multiple types of information that provide means for aiding in the content provisioning and sharing process. The database 250 includes various information related to documents, topics, and the like. It is understood that any other suitable data can be included in the database 250.

In one embodiment, the database 250 includes a machine-learning based training database with a pre-defined mapping defining a relationship between various input parameters and output parameters based on various statistical methods. For example, the training database includes machine-learning algorithms to learn mappings between input parameters related to the documents 110. In an embodiment, the training database is routinely updated and/or supplemented based on machine-learning methods.

The document processing platform 200 communicates with other components of the communication infrastructure 105 using well known, new or still developing protocols. In this context, a protocol includes a set of rules defining how the network nodes within the communication infrastructure 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers.

In operation, the network environment 100 provides a framework for processing and analyzing large amounts of document content, leveraging the capabilities of document structure detection and database technologies to support a wide range of use cases and applications. For example, the network environment 100 can also be used to extract information from the documents 110, or to process structures within one or more documents 110.

To perform these tasks, the document processing platform 200 utilizes, in some embodiments, various techniques such as section identification module 210, which identifies and categorizes different sections in the document, such as headers, footnotes, or body text. The document processing platform 200 can also utilize the layout detection module 220, which identifies and extracts the main layouts or formatting styles used in the documents 110.

To support the storage and retrieval of data related to the document 110, the database 250 can be used to store metadata about the documents 110, such as author, date, and content type. The database 250 can also be used to store any extracted information from the document processing platform 200, such as section information or layout details identified in the documents 110.

In addition to the aforementioned use cases, the network environment 100 can be used to support a wide range of other applications and tasks, such as search and recommendation systems, text summarization, and data visualization. For instance, the network environment 100 can be utilized to construct a search engine that allows users to search for particular keywords or phrases within one or more documents 110, returning a list of relevant documents and information about the contexts in which the keywords or phrases appear.

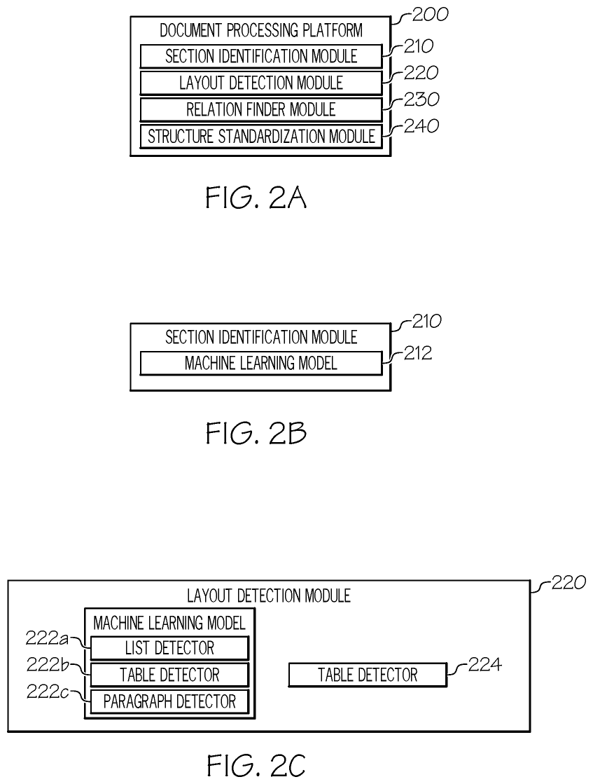

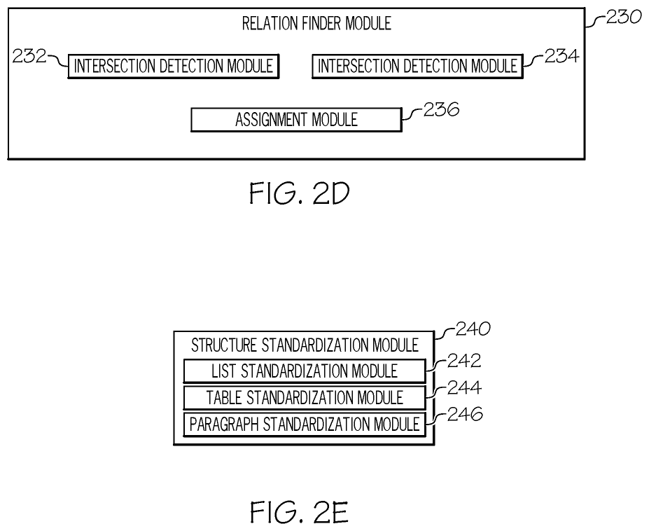

FIG. 2a is a diagram of example components of a document processing platform, according to some embodiments of the disclosure. Referring to FIG. 2a, the document processing platform 200 is a component of the network environment 100. The document processing platform 200 provides the text analysis capabilities necessary to analyze and extract information from one or more documents 110. As used herein, terms such as “component” or “module” generally encompass hardware and/or software, e.g., that a processor or the like is used to implement associated functionality. By way of example, the document processing platform 200 includes one or more components for predicting and/or detecting text and/or identifying one or more section and/or layout of a document. It is contemplated that the functions of these components are combined in one or more components or performed by other components of equivalent functionality. The document processing platform 200 includes one or more modules, such as a section identification module 210, a layout detection module 220, a relation finder module 230, and a structure standardization module 240, or any combination thereof.

FIG. 2b is a diagram of example components of a section identification module, according to some embodiments of the disclosure. The section identification module 210 identifies sections within the one or more documents 110. The section identification module 210 comprises a machine-learning model 212, which utilizes programmed algorithms for identifying the distinct sections within the document 110. The criteria for identification can be variable, and can be set according to formatting styles, keywords, location, size or type of text, among other elements. The output of the machine-learning model 212 is an index of identified sections. This index includes information about each section's location within the document 110.

Each section's location is defined by a section bounding box. The section bounding box is a graphical construct outlined by four coordinates. The bounding box is a visual representation of the section within the document 110, aiding in distinguishing the section from other elements in the document. The section bounding box is defined by four coordinates that outline the region of an identified section within the document 110. The bounding box is a rectangle, with the four coordinates representing the four corners of this rectangle: the top-left corner, the top-right corner, the bottom-right corner, and the bottom-left corner.

These corners essentially map out the spatial confines of an identified section within the document 110. The top-left corner of the bounding box indicates the starting point of the section at its upper leftmost boundary, while the bottom-right corner signifies the ending point of the section at its lower rightmost boundary. Conversely, the top-right corner outlines the upper rightmost boundary, and the bottom-left corner marks the lower leftmost boundary of the section.

It is within these established confines of the section bounding box that subsequent document processing tasks are carried out, aiding in maintaining the structure and integrity of the document while also allowing for targeted manipulation and analysis of individual sections.

The bounding box not only demarcates the identified section within the document 110 but also serves as a reference point for the document processing platform 200. The four corner coordinates of each bounding box can be stored in the database 250, providing an easily retrievable reference for the location and extent of each section within the document.

FIG. 2c is a diagram of example components of a layout detection module, according to some embodiments of the disclosure. The layout detection module 220 is designed to discern different layout structures within one or more documents 110. In some embodiments, layout detection module 220 includes machine-learning model 222, which employs machine learning techniques to identify and categorize different layouts within a document. The machine-learning model 222 is further subdivided into multiple specialized detectors, including a list detector 222a, a table detector 222b, and a paragraph detector 222c. These detectors, in some embodiments, are incorporated within machine-learning model 222, while in some embodiments they are sub-modules which assist the machine-learning model in detecting one or more layouts of the document.

The list detector 222a is trained to identify portions within a document 110 that are formatted in list form. The list detector detects any lists, or assists the machine-learning model 222 in detecting lists, regardless of their structure or complexity, present in the document 110, identifying and classifying list-structured data therein. The table detector 222b is trained to identify portions in a document 110 formatted as tables. The table detector 222b detects tables, or assists the machine-learning model 222 in detecting tables, within the document 110, identifying and classifying table-structured data therein. The paragraph detector 222c is trained to identify portions in the document 110 formatted as paragraphs. The paragraph detector 222c detects portions within the document 110 that are written in paragraph form or “text blob” form, or assists the machine-learning model 222 in detecting paragraphs, identifying and classifying paragraph-structured data therein.

Resolving potential conflicts that might arise during the detection process is the responsibility of the resolver 224. In scenarios where a certain layouts of a document 110 have conflicting bounding boxes, the resolver 224 intervenes. Its role is to evaluate the conflicting bounding boxes of one or more layouts and determine the most appropriate layout configuration based on the available data associated with each layout involved in the conflict.

FIG. 2d is a diagram of example components of a relation finder module, according to some embodiments of the disclosure. The relation finder module 230 is responsible for establishing the relationship between the identified sections within one or more documents 110 and one or more corresponding layouts, as detected by the layout detection module 220. In some embodiments, the relation finder module 230 includes several specialized sub-modules that work in concert to accomplish its objective. These sub-modules comprise an intersection detection module 232, an area determination module 234, and an assignment module 236. Each sub-module plays a role in the overall functioning of the relation finder module 230.

The intersection detection module 232, in some embodiments, identifies intersections or overlaps between the bounding boxes of one or more sections, as determined by the section identification module 210, and the detected layouts, as determined by the layout detection module 220. Following the identification of intersections, the area determination module 234 calculates the areas of the detected intersections or overlaps. The module 234 employs algorithms to quantify the degree of intersection between the sections and layouts. The assignment module 236 assigns or otherwise associates a section to one or more corresponding layout, or vice versa. Utilizing the intersection areas and other relevant parameters, the assignment module 236 ensures that, where appropriate, each section is associated with one or more layouts. This process contributes to the proper organization and structure of the content within the document processing platform 200.

FIG. 2e is a diagram of example components of a structure standardization module, according to some embodiments of the disclosure. The structure standardization module 240 is designed to process and standardize various structural elements of one or more documents 110, including but not limited to lists, tables, and paragraphs. The purpose of such standardization is to generate type-agnostic OCR information, ensuring that the contents of the document remain accessible and searchable regardless of their original format.

The structure standardization module 240, as depicted in FIG. 2e, in some embodiments, includes three primary sub-modules: a list standardization module 242, a table standardization module 244, and a paragraph standardization module 246. The list standardization module 242 is configured to standardize list structures within the document. The list standardization module 242 intakes the previously identified list formats, including but not limited to bullet points, numbered items, or multi-level lists, and converts these lists into a standardized format. The table standardization module 244 is configured to standardize table structures within the document. The table standardization module 244 is capable of handling tables of varying complexity, from simple two-column tables to complex multi-row, multi-column tables with headers and footers. The table standardization module 244 intakes previously identified table formats and converts these various table formats into a standardized structure. The paragraph standardization module 246 intakes the previously identified paragraph portions and/or “text blobs” within the document. The paragraph standardization module 246 identifies paragraph boundaries and content and standardizes the associated data into a standardized format.

The standardized output (e.g., the standardize format) generated by the structure standardization module 240 is a unified presentation of the content of one or more documents 110, optimized for compatibility and ease of processing. This output encapsulates both the content and the contextual meta-information of the document, enhancing its accessibility and searchability. For instance, the meta-information may include headers or tags that identify and associate the content with specific pages, sections, or layouts of the document. These tags serve as a navigational aid, enabling users to locate relevant content with precision and ease. Further, the content of the document, whether it is list data, table data, or paragraph text, is stripped of its original formatting and standardized into a uniform text format. This ensures that the OCR information remains compatible across various platforms and applications, thereby increasing the document's interoperability and versatility. The result is a comprehensive, type-agnostic representation of the document that combines context-aware meta-information with universally compatible text data, providing a robust and flexible solution for document processing and management.

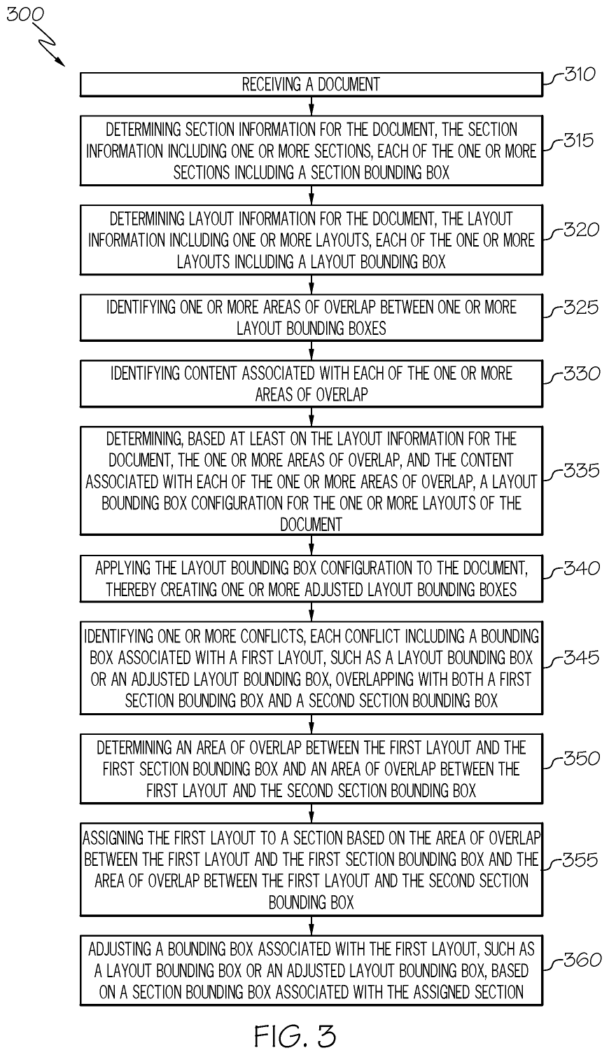

FIG. 3 is a flowchart showing a method for processing a document, according to some embodiments of the disclosure. In some embodiments, FIG. 3 is a flowchart of an example of a process 300 for processing a document. At Step 310, a document is received by the document processing platform 200. At this stage, the communication infrastructure 105 facilitates the transfer of one or more documents 110 into and/or through the network environment 100. The received document is then subject to pre-processing by the document processing platform 200. This pre-processing phase, in some embodiments, entails the division of the document into individual pages, thus breaking down the overall content into manageable units for subsequent processing stages.

During this process, the document processing platform 200 is further configured to extract the inherent metadata from the document. Metadata extraction involves the retrieval of additional data attributes, such as the title of the document, the author, and the publication date, amongst other elements. These extracted data attributes provide context and contribute to a comprehensive understanding of the document's provenance and content.

It should be noted that the document processing platform 200 may accommodate a variety of document formats, including but not limited to PDF, DOCX, TXT, RTF, HTML, or the like. This ensures that the document processing platform 200 is capable of processing a wide array of document types, thus enhancing its versatility and applicability in diverse use-cases.

The document receiving and pre-processing operations are executed by the processor of the document processing platform 200. The processor is responsible for implementing the prescribed algorithmic operations and managing the computational resources to ensure efficient and accurate processing of the document. The processed data is then ready to be passed on to the next stage of the document processing methodology, wherein further detailed analyses are performed to extract and organize the content of the document.

At step 315, the method includes determining section information for the document. The section information includes, in some embodiments, one or more sections, each section including a section bounding box. Document processing platform 200, through the functionality of the section identification module 210, conducts step 315. In this step 315, section identification module 210 recognizes each distinct section present within document 110. A ‘section,’ as utilized in this context, represents a distinct partition or constituent of document 110, the distinction of which, in some embodiments, is rendered by the kind of content it embodies or the spatial relationship of content within the document. Sections identified are not restricted to, but may incorporate headings, paragraphs, images, tables, lists, or similar entities. In certain embodiments, a section is a conceptual representation of data and/or text sharing contextual correlation, such as a section enlisting diagnoses in a medical document. Each of these sections associates with a section bounding box delineating the spatial extent of the section within the layout of a page of document 110.

Section identification module 210 determines section information, encompassing the type of each section and the affiliated section bounding box. This information serves to conceptually provide a spatial and typographical blueprint of document 110, augmenting a holistic understanding of the document structure. Furthermore, section identification module 210 conducts analysis of the visual and textual hierarchy of sections within document 110. This analysis includes comprehension of relationships and order amongst distinct sections based on position, size, style, and additional visual characteristics, as well as textual properties such as the order of paragraphs or subsections, the nesting of list items, the arrangement of cells within a table, or similar attributes.

Certain embodiments incorporate machine learning models to carry out section identification within documents. These models, situated in the section identification module 210, undergo training on a substantial corpus of annotated documents to discern various section types, such as headings, paragraphs, and tables. The models utilize visual cues (for instance, position, size, color) and textual attributes (for instance, font size, style, bold or italic usage) for section identification. Based on task complexity, diverse model architectures may be employed. Convolutional Neural Networks (CNNs) may be employed to process visual data, while Recurrent Neural Networks (RNNs) or Transformer models manage sequential or context-based text data. In some embodiments, these machine learning models also infer the hierarchical relationship amongst sections based on learned structural rules of documents. For instance, a model might identify a bolded text at the top as a heading and subsequent indented text as its paragraph. The prediction outputs of the machine learning models are refined and validated by the processor, thereby yielding efficient and accurate section identification across diverse document formats. This data is stored in database 250 for future document processing steps.

The section identification module 210, in some embodiments, performs these operations under the control of the processor within the document processing platform 200. The resulting section information, including the section bounding boxes and the analyzed hierarchy, are stored in the database 250 for subsequent steps of the document processing methodology.

In some embodiments, the section bounding boxes are constituted of data indicative of multiple points, which define the geometric shape and spatial extent of each bounding box. Specifically, in certain implementations, these points correspond to the corners of the bounding box, outlining a polygonal area within which a specific section of the document resides. In some embodiments, a section bounding box is depicted by four points, representative of the four corners of the box. Each point is defined by a pair of Cartesian coordinates (x, y) in the two-dimensional space of a document page, where ‘x’ and ‘y’ denote the horizontal and vertical positions, respectively. The points are ordered in a sequence that traces the perimeter of the bounding box, usually in a clockwise or counter-clockwise direction, starting from a specific point such as the top-left corner.

The arrangement of these points in the defined order outlines the bounding box, which commonly takes the shape of a quadrilateral. For instance, a rectangular or square bounding box, which is the most prevalent form, is defined by four points that form right angles. Notably, while the bounding box frequently adopts a four-sided configuration, the present disclosure does not limit the bounding box to such a form. In some embodiments, the bounding box may be defined by more than four points. This adaptation accommodates document sections of irregular geometric shapes that cannot be accurately encapsulated by a four-sided bounding box. The points, in these scenarios, are ordered to trace the most accurate and tightest possible boundary around the section. The additional points allow for the bounding box to conform to the shape of the section, thereby enabling a more precise depiction of the spatial extent and orientation of the section within the document page. In some embodiments, section bounding box data is stored in the database 250 and processed by the processor within the document processing platform 200.

At step 320, the method includes a determination of layout information for the document 110. This step, in some embodiments, by the layout detection module 220 of the document processing platform 200. During this step 320, the layout detection module 220 assesses the document 110 in its entirety to identify one or more layouts. Each layout is associated with a layout bounding box, which encapsulates the spatial extension of the layout on a given page of the document 110. The layout detection module 220, in some embodiments, utilizes machine learning algorithms to classify and identify the various layouts within document 110. The algorithms employed may include supervised learning algorithms, unsupervised learning algorithms, or a combination of both. These algorithms are trained on a large dataset of different document layouts, enabling them to recognize and categorize different layouts based on the spatial relationships and arrangements of the various elements within the document.

The layout detection module 220 applies these trained algorithms to the document 110. It proceeds by segmenting the document and assigns a layout classification based on the segmentation. The document segmentation may be achieved using methods like edge detection, connected-component labeling, or other suitable techniques. After this segmentation, the layout detection module 220 can recognize distinct areas in the document corresponding to different layouts.

Each layout is then encapsulated within or associated with a layout bounding box. In some embodiments, the layout bounding boxes are constituted of data indicative of multiple points, which define the geometric shape and spatial extent of each bounding box. Specifically, in certain implementations, these points correspond to the corners of the bounding box, outlining a polygonal area within which a specific layout of the document resides. In some embodiments, a layout bounding box is depicted by four points, representative of the four corners of the box. Each point is defined by a pair of Cartesian coordinates (x, y) in the two-dimensional space of a document page, where ‘x’ and ‘y’ denote the horizontal and vertical positions, respectively. The points are ordered in a sequence that traces the perimeter of the layout bounding box, usually in a clockwise or counter-clockwise direction, starting from a specific point such as the top-left corner.

The arrangement of these points in the defined order outlines the layout bounding box, which commonly takes the shape of a quadrilateral. For instance, a rectangular or square bounding box, which is the most prevalent form, is defined by four points that form right angles. Notably, while the bounding box frequently adopts a four-sided configuration, the present disclosure does not limit the layout bounding box to such a form. In some embodiments, the layout bounding box may be defined by more than four points. This adaptation accommodates document layout of irregular geometric shapes that cannot be accurately encapsulated by a four-sided bounding box. The points, in these scenarios, are ordered to trace the most accurate and tightest possible boundary around the layout. The additional points allow for the bounding box to conform to the shape of the layout, thereby enabling a more precise depiction of the spatial extent and orientation of the layout within the document page. In some embodiments, layout bounding box data is stored in the database 250 and processed by the processor within the document processing platform 200.

In certain embodiments of the disclosed method, situations may arise wherein one or more identified layouts present a spatial overlap with one or more other identified layouts. In these scenarios, the prescribed method encompasses one or more dedicated steps designed to mitigate conflicts that exist within the layout bounding boxes. Such conflict resolution steps may involve the utilization of a designated entity, herein referred to as resolver 224. The resolver 224, in some embodiments, serves to provide a systematic approach to discern the boundaries of intersecting layout bounding boxes and assigns priority or one or more new layout bounding boxes, in case of overlapping content, based on predefined rules or learned patterns, thus ensuring the optimal and accurate representation of the document's spatial organization.

At step 325, the method includes identifying one or more areas of overlap between one or more layout bounding box. This process, in some embodiments, is undertaken by the resolver 224, The resolver 224, with its algorithmic enhancements, systematically compares the spatial parameters (e.g., positions, dimensions, orientations) that define these bounding boxes. Following this comparative analysis, the resolver 224 performs an operation wherein it recognizes areas where two or more bounding boxes intersect or overlap. These overlapping areas, in some embodiments, indicate coexisting multiple layouts or the presence of anomalies in the layout structure which may cause inaccuracies in later OCR processing of the document.

Resolver 224 executes these operations under the guidance of the processor housed within the document processing platform 200. The overlapping areas, the associated content, and the extracted stylometric features are aggregated and stored within the database 250 for use in subsequent processing stages.

At step 330, the process also includes identifying content linked with each overlap area. Each identified overlapping area may contain the content associated with each layout bounding box within these intersections. The content could consist of various section types, including, but not limited to, paragraphs, images, tables, lists, headings, or the like. Resolver 224 facilitates the analysis of stylometric features within the associated content. Stylometric features, in some embodiments, refer to elements such as font type, size, color, text orientation, line spacing, paragraph indentation, or the like. These features offer additional insights into the document formatting and style. The extracted content and the stylometric features from the overlapping areas, identified by the resolver 224, are collated and recorded in the database 250.

At step 335, the method includes determination of a layout bounding box configuration for one or more of the layouts within the document 110, which is executed by resolver 224. Utilizing the processed data which comprises the layout information for the document, the identified areas of overlap, and the associated content within each overlapping area, resolver 224 makes strategic decisions to propose an optimal layout bounding box configuration. The operation of resolver 224 is underpinned by a set of predefined rules and heuristics, coupled with data-driven insights derived from the processed information. Resolver 224 calculates an optimal configuration for the layout bounding boxes for one or more layouts where a conflict is present. This configuration comprises a distinct bounding box for each layout, designed to minimize overlap and provide a clear, logical separation of different content types within the document.

In the event of overlap, resolver 224 proceeds to implement conflict resolution measures to disambiguate the overlapping regions. Such measures might include modifying the size, shape, or position of the overlapping bounding boxes, or reallocating the content within the overlapping areas to a more appropriate bounding box, depending on the context and nature of the content. Upon concluding the layout bounding box configuration determination, resolver 224 communicates this configuration to the processor.

The resolver, in some embodiments, utilizes an algorithmic approach to identifying and resolving the overlap. The resolver may take as input coordinates of one or more bounding boxes along with OCR text associated with each one or more bounding box. The initial operation uses a function that calculates the overlapping area between first and second bounding boxes, producing a quantitative result of overlapping area. The function accepts two bounding boxes (BB1 and BB2) as inputs and computes the area of overlap between them. Initially, the function sets a variable ‘area’ to zero, which serves as a placeholder for the result. The computation involves two stages: Dx and Dy calculations. Dx is computed as the difference between the minimum of the two bounding boxes' maximum x-coordinates (BB1.xmax, BB2.xmax) and the maximum of their minimum x-coordinates (BB1.xmin, BB2.xmin). Similarly, Dy is calculated as the difference between the minimum of the bounding boxes' maximum y-coordinates (BB1.ymax, BB2.ymax) and the maximum of their minimum y-coordinates (BB1.ymin, BB2.ymin). These calculations determine the horizontal (Dx) and vertical (Dy) dimensions of the overlapping region, if one exists, between the two bounding boxes. The function then evaluates whether both Dx and Dy are greater than or equal to zero. This check ensures that a valid overlapping area exists, as negative values would indicate a lack of overlap. If this condition is met, the function calculates ‘area’ as the product of Dx and Dy, which represents the area of the overlap. The function concludes by returning the computed ‘area’. If there was no overlap between the bounding boxes, ‘area’ remains zero, signifying a lack of overlap. Conversely, a positive ‘area’ value signifies a valid overlapping region between BB1 and BB2, with the value indicating the magnitude of the overlap.

If the result of the first operation exceeds zero, indicating some degree of overlap between BB1 and BB2, the process advances to further assessment. This secondary evaluation utilizes another function to identify text overlap, which is designed to calculate the overlap of the text within the overlapping bounding boxes (BBT1 and BBT2). To initiate this operation, the text contained within each bounding box is first divided into individual words. This is achieved by implementing a word split function on both BBT1 and BBT2, yielding two sets of words, namely a first set of words associated with BBT1 and a second set of words associated with BBT2. Next, the function determines the count of words in each of the two bounding boxes. This step results in two numerical outputs representing the quantity of words in BBT1 and BBT2, respectively. Following the above operations, the function identifies the intersecting words between the two bounding boxes. This is achieved using a set intersection operation (which results in a new set of words that are common to both BBT1 and BBT2, resulting in an intersection set). The function calculates and returns the ratio of the count of intersecting words to the count of words in the bounding box with the lesser number of words. This value serves as a measure of the relative overlap between the text within BBT1 and BBT2, and is the output produced by the overlap function. This calculation produces a numerical output representing the text overlap.

The process may further include, in some embodiments, a check for syntax. The function for checking syntax provides a mechanism to assess the syntactical features of the textual content within two bounding boxes, namely BBT1 and BBT2. The function starts by identifying the initial and final characters of the text within both bounding boxes. These characters are referred to as ‘start1’ and ‘end1’ for BBT1, and ‘start2’ and ‘end2’ for BBT2, respectively. Following this initial step, the function performs a series of comparisons to evaluate syntactic consistency. It first checks if the initial character of BBT1 (‘start1’) is a capital letter while the initial character of BBT2 (‘start2’) is not. If this condition is true, the function immediately returns a positive result (True), suggesting a potential syntaxical connection between BBT1 and BBT2. Should the initial condition be unmet, the function then checks the converse scenario, e.g., if ‘start2’ is a capital letter and ‘start1’ is not. A positive result in this scenario also leads to an immediate return of True by the function. In the event of both initial character checks failing, the function moves on to evaluate the final characters of the bounding box texts. It first verifies if ‘end1’ is a full stop and ‘end2’ is not. If this condition holds, the function returns True, indicating a syntaxical link between the two bounding boxes. If the previous check fails, the function investigates the opposite condition, where ‘end2’ is a full stop and ‘end1’ is not. A positive result at this stage also leads to the function returning True. In case none of the above conditions are met, the function concludes that there is no detectable syntaxical connection between BBT1 and BBT2 and thus returns False. This output signifies the absence of a syntaxical link that would be indicative of a coherent continuation or partition of textual content between the two bounding boxes.

In some embodiments, if numerical output for the overlap step exceeds a predetermined threshold value, a merging function is, in some embodiments, called upon to combine BB1 and BB2 into a singular bounding box. The function starts by distinguishing the two bounding boxes based on their y-coordinates, the outcome of this yielding a labeling of an ‘Upper’ bounding box and a ‘Lower’ bounding box. The subsequent step involves determining the top-left and bottom-right coordinates of both ‘Upper’ and ‘Lower’ bounding boxes. This provides the x and y minimum coordinates for the top-left point and the x and y maximum coordinates for the bottom-right point of each box.

Thereafter, the function sets the minimum x and y coordinates of the new bounding box to be equal to those of the ‘Upper’ bounding box. It then checks the y maximum coordinate of both bounding boxes. If the ‘Upper’ bounding box has a greater y maximum coordinate, it implies that the ‘Upper’ bounding box also extends further along the x-axis, thus the maximum x and y coordinates of the new bounding box are set to match those of the ‘Upper’ bounding box. Otherwise, if the ‘Lower’ bounding box has a greater y maximum coordinate, it signifies that the ‘Lower’ bounding box extends further along both the x and y axes, in which case the maximum x and y coordinates of the new bounding box are set to match those of the ‘Lower’ bounding box.

The function culminates in the creation of a new, modified, or merged bounding box, which represents the coordinates of the merged bounding box, formed by the combination of BB1 and BB2. This coordinate set comprises the minimum and maximum x and y coordinates determined in the previous steps, and is returned as the output of the function. This single bounding box represents the combined area covered by the original two bounding boxes, thus encapsulating the overlap between them.

At step 340, the method includes applying the layout bounding box configuration to the document 110. This step engenders the creation of one or more adjusted layout bounding boxes based on the configuration determined by resolver 224 in the preceding step. During this step, the processor receives the optimally configured layout bounding box details from resolver 224. The processor then proceeds to integrate this configuration into the document 110, adjusting the spatial parameters of the existing layout bounding boxes in accordance with the proposed configuration. The adjustments may encompass changes in the position, size, shape, or orientation of the bounding boxes, as stipulated by the resolver-determined configuration.

The application of the adjusted bounding box configuration serves to enhance the structure and coherence of the document 110, providing clearer differentiation between distinct layouts and minimizing spatial conflicts within the document. Each adjusted layout bounding box, in some embodiments, encapsulates a discrete layout, providing a more accurate and functional representation of the layout's extent and position within the document.

In certain embodiments, the resulting layout bounding box configuration may lead to a scenario where two or more previously distinct layouts are combined into a single unified layout. This amalgamation may occur when resolver 224 determines, based on the analyzed spatial and content data, that the considered layouts possess sufficient similarity or content continuity to warrant a unified representation. The merger of these layouts results in an adjusted bounding box that encapsulates the combined area previously assigned to the individual layouts. Moreover, it should be understood that in certain embodiments, the method involving the resolver 224 is not a singular process but can be undertaken iteratively. This iterative nature becomes particularly salient when multiple layout conflicts are identified within a document. In such instances, resolver 224 may execute multiple cycles of overlap resolution and layout bounding box adjustment, each cycle targeting a different area of overlap or layout conflict. With each iteration, the configurations of layout bounding boxes are progressively refined, successively reducing layout overlap and spatial conflicts within the document 110.

At the conclusion of each iteration, the processing unit applies the updated layout bounding box configuration to the document, producing adjusted bounding boxes that reflect the most recent conflict resolution. The iteration process ceases once all detected layout conflicts have been addressed, yielding a final layout bounding box configuration that optimally represents the spatial structure and content arrangement within the document 110. This iterative resolution mechanism underscores the versatility and adaptability of resolver 224 in effectively handling complex document layouts with multiple overlapping or conflicting areas.

At step 345, the method proceeds with the identification of one or more conflicts, facilitated by the relation finder module 230, specifically utilizing the intersection detection module 232. Each conflict is defined by a scenario where a bounding box associated with a first layout, which could be either a layout bounding box or an adjusted layout bounding box, overlaps both a first section bounding box and a second section bounding box. Consequently, the layout is not intuitively associated with either the first or second section, engendering a conflict in content attribution.

The determination of these conflicts, in some embodiment, utilizes the coordinates delineating the bounding boxes for both sections and layouts. By comparing the coordinates of these bounding boxes, the intersection detection module 232 establishes spatial intersections indicative of conflicts. Specifically, the intersection detection module 232 verifies if the bounding box of a layout falls within the boundaries of a section bounding box or vice versa, signifying an overlap. It also checks whether a layout bounding box overlaps more than one section bounding box, further indicating a conflict scenario.

At step 350, the method includes determining an area of overlap between the first layout and both the first and second section bounding boxes, a process that is facilitated by the relation finder module 230, specifically employing the area determination module 234. Once the conflicts have been identified, the area determination module 234 computes the exact areas of overlap between the layout and the section bounding boxes. To accomplish this, it systematically examines the spatial parameters of the involved bounding boxes. Specifically, it extracts the coordinates of the overlapping regions between the layout and each section bounding box.

The overlapping area with the first section bounding box is calculated as the spatial region where the layout bounding box and the first section bounding box intersect. Likewise, the overlapping area with the second section bounding box is determined as the spatial region of intersection between the layout bounding box and the second section bounding box.

At step 355, the method includes assigning the first layout to a section, which is facilitated by the relation finder module 230, specifically the assignment module 236. The assignment process is based upon the computed areas of overlap between the first layout and the respective section bounding boxes, e.g., the first and the second section bounding box.

The assignment module 236 performs a comparison operation, evaluating the magnitude of the overlapping areas. The layout is then associated with the section that has the larger overlapping area. In some embodiments, this association can be formulated as a binary decision: the layout is assigned to the section bounding box that it has the larger overlap with. In some embodiments, where the areas are exactly equal, the layout may be assigned randomly. Alternatively, the assignment could be probabilistic, assigning a likelihood of association with each section, proportional to the areas of overlap.

The assignment module 236 can also accommodate complex scenarios where the layout overlaps with multiple section bounding boxes. In such cases, the module may repeat the comparison operation for all involved sections, until the layout is assigned to the most suitable section based on the overlap areas. It is noteworthy that this assignment process is adaptable and iterative, ensuring precision and accuracy in layout-section association.

At step 360, the method includes adjusting a bounding box associated with the first layout, such as a layout bounding box or an adjusted layout bounding box, based on a section bounding box associated with the assigned section. This step is facilitated by the document processing platform 200 in association with the intersection detection module 232, area determination module 234, and assignment module 236, each being a component of the platform 200.

The term “adjusting,” as applied herein, encompasses the modification, alteration, or refinement of the dimensionality or positional characteristics of the layout bounding box. This is dictated by the attributes of the assigned section bounding box. The adjustments might encompass modifications to any of the layout bounding box's attributes, including but not limited to, length, breadth, orientation, or placement within the document or page layout. These modifications could range from minor tweaks that change the layout bounding box by slight margins, to more substantial alterations that significantly rearrange the layout bounding box.

The assignment module 236 primarily conducts the adjustment operation, in conjunction with the intersection detection module 232 and area determination module 234. These operations entail calculating disparities in dimensions and positions between the layout bounding box and the assigned section bounding box, resolving these disparities by altering the layout bounding box's attributes, and subsequently validating these changes for the sake of the document's visual and structural integrity.

The adjustment operation, in the course of refining the layout bounding box, adheres to a multitude of constraints and guidelines. These include but are not limited to maintaining the overall hierarchy and relative positions of the sections, ensuring a minimum distance between adjacent sections, and preserving the legibility of the document contents.

Post completion of the layout bounding box adjustment at step 360, the method iteratively progresses towards further refining the layout bounding box configuration, resolving any outstanding conflicts, and aligning the layout with the document's overall visual and structural coherence. As such, the adjustment operation facilitates the successful integration of layouts and sections within the document, thereby ensuring a harmonious and aesthetically pleasing document structure.

In some embodiments, one or more aspects of the method utilize certain data structures for determining spatial access and comparisons. For example, in some embodiments, an R-tree data structure is utilized in step 345. The R-tree data structure, in accordance with certain embodiments, is a tree data structure that is utilized for indexing multi-dimensional information, such as geographical coordinates and rectangles. The R-tree data structure typically comprises a number of nodes, each of which can be either a leaf node or a non-leaf node. Each node in the R-tree data structure, as per certain embodiments, contains entries. Each entry within a non-leaf node consists of two components: (1) a multi-dimensional bounding rectangle (MBR), and (2) a pointer to a child node. The MBR is an enclosure that encompasses all MBRs in its corresponding child node. For leaf nodes, each entry consists of an MBR and a pointer to a data record. The R-tree data structure in these embodiments is created and updated through processes of splitting and condensing. When an entry is added to a node that exceeds the maximum capacity of that node, the node is split into two or more nodes, ensuring the distribution of MBRs among the new nodes minimizes the total area, margin, or overlap of the MBRs. If an entry is deleted from a node and that node falls below a certain minimum capacity, a condense tree operation is triggered to prune and reinsert the entries in that node. In some embodiments, the search operation in an R-tree data structure involves traversing the tree from the root node to the leaf nodes, following child nodes whose MBRs intersect the search query.

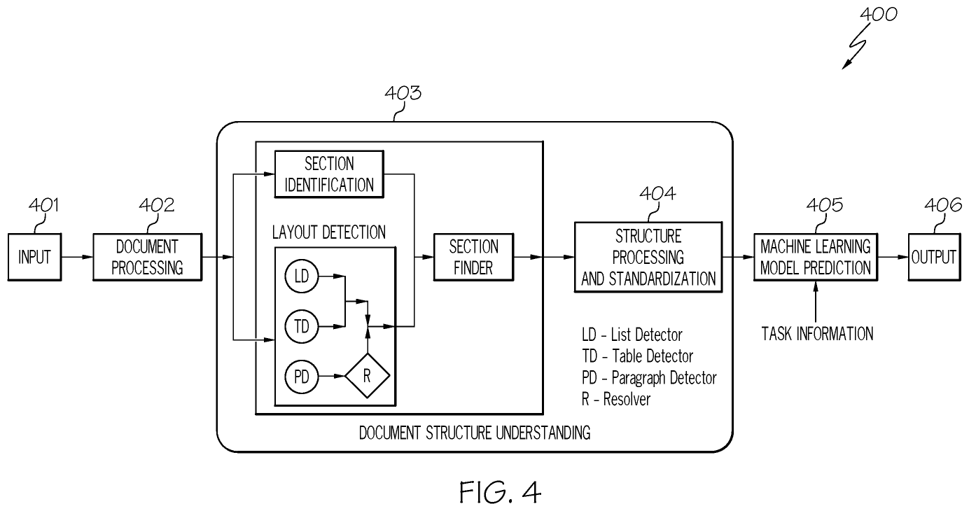

FIG. 4 is a flowchart showing a method for processing a document, according to some embodiments of the disclosure. In some embodiments, FIG. 4 is a flowchart of an example of a process 400 for processing a document for optimized optical character recognition, according to some embodiments of the disclosure. FIG. 4 includes step 401 for receiving an input, step 402 which includes processing or pre-processing a document, and 403, which includes section identification, layout identification, resolving conflicts, and determining relations. These steps, in some embodiments, are similar to those conducted in the process of FIG. 3. It will be appreciated that one or more steps of the process 300 of FIG. 3 may be incorporated with one or more steps of the process 400 of FIG. 4.

In the operation of the method as presented in FIG. 4, step 404 encapsulates the processing and standardization of the document's structure. The document processing platform 200, in this step, involves the utilization of one or more structure standardization modules, including but not limited to structure standardization module 240, list standardization module 242, table standardization module 244, and paragraph standardization module 246. This step ensures that the document's content, which can include a diverse range of data formats such as text, lists, tables, and other structures, is transformed into a standardized, format-agnostic data model.

In greater detail, the structure standardization module 240 handles the general standardization of document structure. It operates by transforming the raw, unprocessed layout data into a standardized structural model. This transformation can involve abstracting the information from its original format into an intermediary representation that accommodates varying formats in a consistent manner. The abstracted information then serves as a flexible and comprehensive representation of the original document, ensuring that no information is lost in the standardization process.

The list standardization module 242 operates specifically on lists detected within the document by the list detector 222a. It acts on the raw list data to transform it into a standardized format that encapsulates the inherent structure of the list, while also abstracting it to a format-agnostic model. This process could include preserving the order of items in the list, retaining any hierarchical relationships present, and also storing associated metadata, such as bullet styles or indentation levels.

On the other hand, the table standardization module 244 engages with tables identified within the document by table detector 222b. This module ensures that the structure of the tables is maintained in a standardized, format-agnostic manner. It processes the raw table data, taking into account rows, columns, cell content, headers, footers, and any other defining attributes of the tables, and generates a corresponding standardized representation. This representation maintains the relational structure of the original table while allowing for flexibility in how the data can be further processed or presented.

In similar fashion, the paragraph standardization module 246 focuses on processing and standardizing paragraph structures within the document, as detected by the paragraph detector 222c. This module transforms the raw paragraph data into a standardized format, while preserving the inherent structure and style of the paragraphs, such as indentation, alignment, line spacing, and other such formatting details. Once all pertinent sections of the document have been standardized, the resultant format-agnostic data serves as a consistent and accurate representation of the original document, ready to be further processed in the subsequent steps of the method, such as in step 405, where the data is used as input for the machine-learning model.

In step 404, the structure standardization module 240, list standardization module 242, table standardization module 244, and paragraph standardization module 246, in some embodiments, convert raw document structure data into standardized formats, ready for further processing or analysis.

The structure standardization module 240 receives raw document data, including data on the overall layout and structure of the document. The input data includes not only the content within the document, but in some embodiments also information about the relative position and spatial arrangement of different sections within each page of the document. The list standardization module 242 takes raw data pertaining to identified lists in the document, which in some embodiments is supplied by list detector 222a. The input data includes the list content, location within the document, and any hierarchical structure of the list. The module processes this data and generates a standardized output that includes tags indicating the page number and sections in which the list is found. Each list tag includes an image of the list, the extracted text from the list, and any substructures within the list, such as sub-lists or nested bullet points.

The table standardization module 244 receives input data related to tables in the document, which in some embodiments is supplied by table detector 222b. The data includes the content within the table, its location, and the structure of the table, such as the arrangement of rows, columns, and cells. The module processes this data and outputs a standardized format that includes tags indicating the page number and sections where the table is found. Each table tag includes an image of the table, the extracted text from the table, and any substructures within the table, such as nested tables or embedded images.

Similarly, the paragraph standardization module 246 processes data related to paragraphs in the document, provided in some embodiments by paragraph detector 222c. The input data includes the paragraph text, its location, and any formatting details like indentation, alignment, or line spacing. The module processes this data and outputs a standardized format that includes tags indicating the page number and sections where the paragraph is found. Each paragraph tag includes an image of the paragraph, the extracted text, and any substructures within the paragraph, such as embedded images, tables, or lists.

In each case, the resulting standardized data includes a comprehensive and format-agnostic representation of the original document structure, ready for further processing in subsequent steps of the method, or for various other potential applications in document processing and management.

OCR may be a component in standardizing document structures for further analysis and processing. In some embodiments, the structure standardization module 240, list standardization module 242, table standardization module 244, and paragraph standardization module 246, each incorporate OCR technology to facilitate this conversion process.

The structure standardization module 240, upon receiving raw data indicative of the overall layout and structure of the document, deploys OCR technology to convert images of text within each document structure into machine-encoded text. This OCR process includes analyzing the optical patterns in the image data and recognizing these patterns as corresponding to specific characters or groups of characters. The output of the OCR process is text data that can be efficiently processed by subsequent steps in the method, or readily analyzed for various document processing or management purposes.

The list standardization module 242 processes data pertaining to identified lists in the document. The OCR technology within this module captures the optical patterns in images of lists, recognizes these patterns as specific text characters, and converts these characters into a machine-readable format. This enables further processing, including hierarchical arrangement of the list items and extraction of relevant data from the lists.

In a similar manner, the table standardization module 244 incorporates OCR technology to analyze optical patterns in images of tables, and to recognize and convert these patterns into machine-encoded text. This allows the module to accurately reproduce the structure of the table in a standardized format, including the arrangement of rows, columns, and cells, and the specific content within each cell.

Likewise, the paragraph standardization module 246 uses OCR to convert images of paragraphs into machine-readable text. This process not only converts the optical patterns in the image into corresponding characters, but in some embodiments also recognizes and preserves the inherent structure and formatting of the paragraph, including indentation, alignment, and line spacing.

In all of these modules, the use of OCR technology enables the extraction of accurate, detailed, and machine-readable data from document structures. The process is designed to be robust and efficient, capable of handling a wide variety of document types and layouts, and to produce standardized output data that is readily adaptable for various document processing, management, and analysis tasks.

At step 405, the process includes a machine-learning model prediction. In the context of this method, machine-learning model 222 is deployed to facilitate an advanced level of text prediction or OCR. The model is designed to accommodate both structured and unstructured data, receiving standardized, format-agnostic data from the preceding modules, including structure standardization module 240, list standardization module 242, table standardization module 244, and paragraph standardization module 246.

Task information, such as specific instructions to identify listings of diagnoses, or other relevant categories or objects within the document, are used to guide the model's predictive operations. This task information serves as a contextual anchor, shaping the model's focus and helping to steer its predictive capabilities toward a more precise, goal-directed output.

Step 405 of the method involves the utilization of a machine-learning model, specifically designed and trained to handle layout-agnostic data. Layout-agnostic data, as referred to herein, is data in which the specific positioning, presentation, or arrangement of information within the data is not a defining or essential characteristic for the comprehension of the information contained therein. The machine-learning model is structured and equipped to intake this type of data irrespective of the layout or configuration of the data, thus providing an inherent level of flexibility and adaptability to the model in handling a wide array of data sources and types.

Furthermore, the machine-learning model in step 405 also processes one or more tasks associated with task information. In this particular embodiment, a task refers to a specific data interpretation or analysis operation, such as identifying diagnoses within a document. Task information denotes specifics related to the tasks, such as the details of the patient for whom the diagnoses are to be identified. It is understood that the task and task information may vary based on the specific use-case scenario or application.

The machine-learning model is trained and adapted to ingest and interpret the layout-agnostic data and associated task information, taking into account the particular details and requirements of the task at hand. Through various machine learning algorithms and techniques, such as natural language processing, deep learning, and others, the machine-learning model parses the data, identifies patterns, draws inferences, and derives the required output related to the task, such as identifying the specific diagnoses in a document for a specific patient.

At step 406, an output from the machine-learning model is produced by document processing platform 200. In the some embodiments, the output constitutes a result related to one or more task information, such as an output of specific diagnoses in a document. It is noteworthy to mention that the output could also include additional related information or insights derived from the layout-agnostic data and task information as per the capacities and capabilities of the machine-learning model employed. This output serves as an end-point of the present step and provides the basis for any subsequent steps, processes, or operations, depending on the particular application or usage scenario of the method.

In alternative embodiments of step 406, the output need not be limited to OCR text. Various other forms of output can be leveraged, significantly expanding the potential utility of the document processing platform 200, particularly within a medical setting. For instance, the output could be configured as structured data sets or databases, which can be seamlessly integrated into existing medical information systems. Instead of generating OCR text, a user interface module, in some embodiments, extracts specific data points from the OCR predictions and organize them into pre-defined data structures. These structured data sets could include patient medical histories, diagnostic results, prescribed medication, or the like. These structured data sets are subsequently stored in the database 250, available for immediate retrieval by other systems or applications within the network environment 100. This embodiment offers the significant advantage of eliminating the need for manual data entry, reducing human errors, and streamlining healthcare processes.

Additionally, the output may also be directed to interactive medical applications or systems. For example, a user interface, in some embodiments, feeds the OCR predictions directly into a symptom checker application, a diagnostic algorithm, or a drug interaction checker. It might also serve to populate electronic health record (EHR) systems, providing information to healthcare professionals and assisting in patient management.

Furthermore, the output can also be formatted for visual representations such as graphs, charts, or other illustrative formats. Such visualization techniques can be particularly valuable in representing complex medical data and trends, making them more comprehensible and accessible to medical practitioners. This could involve, for instance, graphically representing patient vitals over time, illustrating population health trends, or mapping disease outbreaks.

Moreover, the output could be configured to trigger automated alerts or actions within the medical setting. For example, a user interface module, in some embodiments, analyzes the OCR predictions and, based on predefined criteria, trigger alerts to medical personnel about potential health risks, medication refill reminders, or the need for follow-up appointments.

In some embodiments, the output could also be utilized for training or refining machine-learning models within the network environment 100. The machine-learning model 222, or other auxiliary machine-learning models within the network environment 100, could use the OCR predictions as input data, helping them improve their performance and prediction accuracy over time.

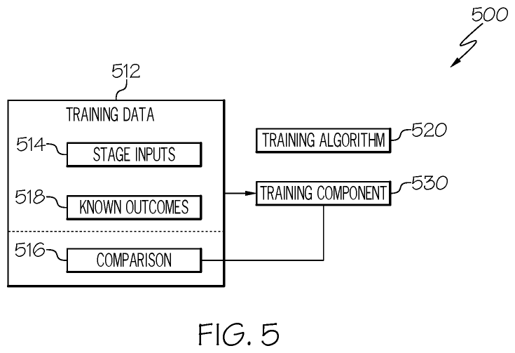

One or more implementations disclosed herein include and/or are implemented using a machine-learning model. For example, one or more of the modules of the prediction platform are implemented using a machine-learning model and/or are used to train the machine-learning model. FIG. 5 shows an example machine-learning training flow chart, according to some embodiments of the disclosure. Referring to FIG. 5, a given machine-learning model is trained using the training flow chart 500. The training data 512 includes one or more of stage inputs 514 and the known outcomes 518 related to the machine-learning model to be trained. The stage inputs 514 are from any applicable source including text, visual representations, data, values, comparisons, and stage outputs, e.g., one or more outputs from one or more steps from FIG. 3 or FIG. 4. The known outcomes 518 are included for the machine-learning models generated based on supervised or semi-supervised training, or can based on known labels, such as topic labels. An unsupervised machine-learning model is not trained using the known outcomes 518. The known outcomes 518 includes known or desired outputs for future inputs similar to or in the same category as the stage inputs 514 that do not have corresponding known outputs.

The training data 512 and a training algorithm 520, e.g., one or more of the modules implemented using the machine-learning model and/or are used to train the machine-learning model, is provided to a training component 530 that applies the training data 512 to the training algorithm 520 to generate the machine-learning model. According to an implementation, the training component 530 is provided comparison results 516 that compare a previous output of the corresponding machine-learning model to apply the previous result to re-train the machine-learning model. The comparison results 516 are used by the training component 530 to update the corresponding machine-learning model. The training algorithm 520 utilizes machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine-learning model used herein is trained and/or used by adjusting one or more weights and/or one or more layers of the machine-learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

In general, any process or operation discussed in this disclosure is understood to be computer-implementable, such as the process illustrated in FIGS. 2a-5 are performed by one or more processors of a computer system as described herein. A process or process step performed by one or more processors is also referred to as an operation. The one or more processors are configured to perform such processes by having access to instructions (e.g., software or computer-readable code) that, when executed by one or more processors, cause one or more processors to perform the processes. The instructions are stored in a memory of the computer system. A processor is a central processing unit (CPU), a graphics processing unit (GPU), or any suitable type of processing unit.

A computer system, such as a system or device implementing a process or operation in the examples above, includes one or more computing devices. One or more processors of a computer system are included in a single computing device or distributed among a plurality of computing devices. One or more processors of a computer system are connected to a data storage device. A memory of the computer system includes the respective memory of each computing device of the plurality of computing devices.

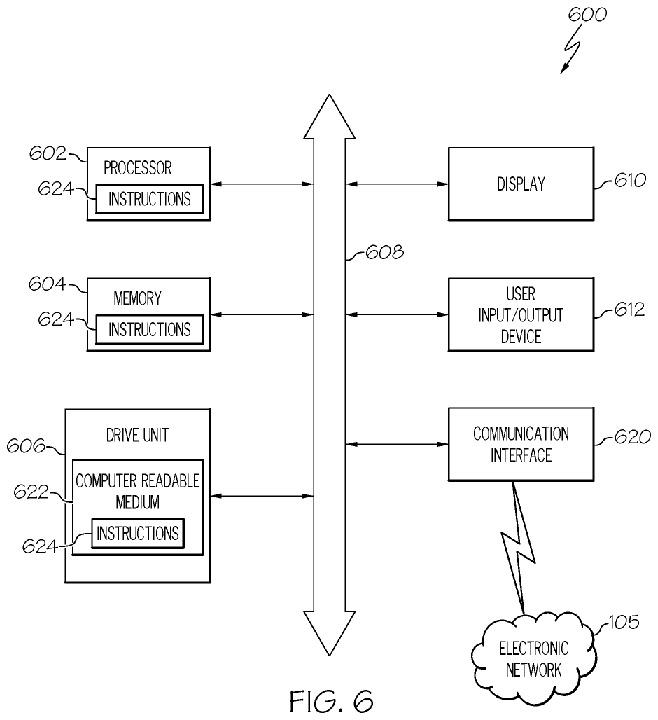

FIG. 6 illustrates an implementation of a computer system that executes techniques presented herein. The computer system 600 includes a set of instructions that are executed to cause the computer system 600 to perform any one or more of the methods or computer based functions disclosed herein. The computer system 600 operates as a standalone device or is connected, e.g., using a network, to other computer systems or peripheral devices.

Unless specifically stated otherwise, as apparent from the following discussions, it is appreciated that throughout the specification, discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” refers to any device or portion of a device that processes electronic data, e.g., from registers and/or memory to transform that electronic data into other electronic data that, e.g., is stored in registers and/or memory. A “computer,” a “computing machine,” a “computing platform,” a “computing device,” or a “server” includes one or more processors.

In a networked deployment, the computer system 600 operates in the capacity of a server or as a client user computer in a server-client user network environment, or as a peer computer system in a peer-to-peer (or distributed) network environment. The computer system 600 is also implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular implementation, the computer system 600 is implemented using electronic devices that provide voice, video, or data communication. Further, while the computer system 600 is illustrated as a single system, the term “system” shall also be taken to include any collection of systems or sub-systems that individually or jointly execute a set, or multiple sets, of instructions to perform one or more computer functions.

As illustrated in FIG. 6, the computer system 600 includes a processor 602, e.g., a central processing unit (CPU), a graphics processing unit (GPU), or both. The processor 602 is a component in a variety of systems. For example, the processor 602 is part of a standard personal computer or a workstation. The processor 602 is one or more processors, digital signal processors, application specific integrated circuits, field programmable gate arrays, servers, networks, digital circuits, analog circuits, combinations thereof, or other now known or later developed devices for analyzing and processing data. The processor 602 implements a software program, such as code generated manually (e.g., programmed).

The computer system 600 includes a memory 604 that communicates via bus 608. The memory 604 is a main memory, a static memory, or a dynamic memory. The memory 604 includes, but is not limited to computer-readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 604 includes a cache or random-access memory for the processor 602. In alternative implementations, the memory 604 is separate from the processor 602, such as a cache memory of a processor, the system memory, or other memory. The memory 604 is an external storage device or database for storing data. Examples include a hard drive, compact disc (“CD”), digital video disc (“DVD”), memory card, memory stick, floppy disc, universal serial bus (“USB”) memory device, or any other device operative to store data. The memory 604 is operable to store instructions executable by the processor 602. The functions, acts, or tasks illustrated in the figures or described herein are performed by the processor 602 executing the instructions stored in the memory 604. The functions, acts, or tasks are independent of the particular type of instruction set, storage media, processor, or processing strategy and are performed by software, hardware, integrated circuits, firmware, micro-code, and the like, operating alone or in combination. Likewise, processing strategies include multiprocessing, multitasking, parallel processing, and the like.

As shown, the computer system 600 further includes a display 610, such as a liquid crystal display (LCD), an organic light emitting diode (OLED), a flat panel display, a solid-state display, a cathode ray tube (CRT), a projector, a printer or other now known or later developed display device for outputting determined information. The display 610 acts as an interface for the user to see the functioning of the processor 602, or specifically as an interface with the software stored in the memory 604 or in the drive unit 606.

Additionally or alternatively, the computer system 600 includes an input/output device 612 configured to allow a user to interact with any of the components of the computer system 600. The input/output device 612 is a number pad, a keyboard, a cursor control device, such as a mouse, a joystick, touch screen display, remote control, or any other device operative to interact with the computer system 600.

The computer system 600 also includes the drive unit 606 implemented as a disk or optical drive. The drive unit 606 includes a computer-readable medium 622 in which one or more sets of instructions 624, e.g. software, is embedded. Further, the sets of instructions 624 embodies one or more of the methods or logic as described herein. The sets of instructions 624 resides completely or partially within the memory 604 and/or within the processor 602 during execution by the computer system 600. The memory 604 and the processor 602 also include computer-readable media as discussed above.

In some systems, computer-readable medium 622 includes the set of instructions 624 or receives and executes the set of instructions 624 responsive to a propagated signal so that a device connected to network 105 communicates voice, video, audio, images, or any other data over the network 105. Further, the sets of instructions 624 are transmitted or received over the network 105 via the communication port or interface 620, and/or using the bus 608. The communication port or interface 620 is a part of the processor 602 or is a separate component. The communication port or interface 620 is created in software or is a physical connection in hardware. The communication port or interface 620 is configured to connect with the network 105, external media, the display 610, or any other components in the computer system 600, or combinations thereof. The connection with the network 105 is a physical connection, such as a wired Ethernet connection, or is established wirelessly as discussed below. Likewise, the additional connections with other components of the computer system 600 are physical connections or are established wirelessly. The network 105 alternatively be directly connected to the bus 608.

While the computer-readable medium 622 is shown to be a single medium, the term “computer-readable medium” includes a single medium or multiple media, such as a centralized or distributed database, and/or associated caches and servers that store one or more sets of instructions. The term “computer-readable medium” also includes any medium that is capable of storing, encoding, or carrying a set of instructions for execution by a processor or that causes a computer system to perform any one or more of the methods or operations disclosed herein. The computer-readable medium 622 is non-transitory, and may be tangible.

The computer-readable medium 622 includes a solid-state memory such as a memory card or other package that houses one or more non-volatile read-only memories. The computer-readable medium 622 is a random-access memory or other volatile re-writable memory. Additionally or alternatively, the computer-readable medium 622 includes a magneto-optical or optical medium, such as a disk or tapes or other storage device to capture carrier wave signals such as a signal communicated over a transmission medium. A digital file attachment to an e-mail or other self-contained information archive or set of archives is considered a distribution medium that is a tangible storage medium. Accordingly, the disclosure is considered to include any one or more of a computer-readable medium or a distribution medium and other equivalents and successor media, in which data or instructions are stored.

In an alternative implementation, dedicated hardware implementations, such as application specific integrated circuits, programmable logic arrays, and other hardware devices, is constructed to implement one or more of the methods described herein. Applications that include the apparatus and systems of various implementations broadly include a variety of electronic and computer systems. One or more implementations described herein implement functions using two or more specific interconnected hardware modules or devices with related control and data signals that are communicated between and through the modules, or as portions of an application-specific integrated circuit. Accordingly, the present system encompasses software, firmware, and hardware implementations.

Computer system 600 is connected to the network 105. The network 105 defines one or more networks including wired or wireless networks. The wireless network is a cellular telephone network, an 802.10, 802.16, 802.20, or WiMAX network. Further, such networks include a public network, such as the Internet, a private network, such as an intranet, or combinations thereof, and utilizes a variety of networking protocols now available or later developed including, but not limited to TCP/IP based networking protocols. The network 105 includes wide area networks (WAN), such as the Internet, local area networks (LAN), campus area networks, metropolitan area networks, a direct connection such as through a Universal Serial Bus (USB) port, or any other networks that allows for data communication. The network 105 is configured to couple one computing device to another computing device to enable communication of data between the devices. The network 105 is generally enabled to employ any form of machine-readable media for communicating information from one device to another. The network 105 includes communication methods by which information travels between computing devices. The network 105 is divided into sub-networks. The sub-networks allow access to all of the other components connected thereto or the sub-networks restrict access between the components. The network 105 is regarded as a public or private network connection and includes, for example, a virtual private network or an encryption or other security mechanism employed over the public Internet, or the like.

In accordance with various implementations of the present disclosure, the methods described herein are implemented by software programs executable by a computer system. Further, in an example, non-limited implementation, implementations can include distributed processing, component/object distributed processing, and parallel processing. Alternatively, virtual computer system processing can be constructed to implement one or more of the methods or functionality as described herein.

Although the present specification describes components and functions that are implemented in particular implementations with reference to particular standards and protocols, the disclosure is not limited to such standards and protocols. For example, standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (e.g., computer) system executing instructions (computer-readable code) stored in storage. It will also be understood that the disclosure is not limited to any particular implementation or programming technique and that the disclosure is implemented using any appropriate techniques for implementing the functionality described herein. The disclosure is not limited to any particular programming language or operating system.

It should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention are practiced without these specific details. In other instances, well-known methods, structures and techniques have not been shown in detail in order not to obscure an understanding of this description.

Thus, while there has been described what are believed to be the preferred embodiments of the invention, those skilled in the art will recognize that other and further modifications are made thereto without departing from the spirit of the invention, and it is intended to claim all such changes and modifications as falling within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

The present disclosure furthermore relates to the following aspects.

Example 1. A computer-implemented method for resolving conflicts in document layout, the method comprising: receiving, by a processor coupled to a memory, layout information for two or more layouts of a document, each layout of the two or more layouts having a layout bounding box; identifying, by the processor, one or more areas of overlap between the layout bounding boxes of the two or more layouts, respectively; identifying, by the processor, content associated with each area of overlap, the content including stylometric features; determining, by the processor and based at least on the layout information for the document, the one or more areas of overlap, and the content associated with each area of overlap, a layout bounding box configuration for the two or more of the layouts of the document; and applying, by the processor, the layout bounding box configuration to the document.

Example 2. The method of example 1, wherein applying the layout bounding box configuration to the document includes replacing the layout bounding box for each layout of the two or more layouts with a respective adjusted layout bounding box, and wherein the adjusted layout bounding boxes for the two or more layouts have no areas of overlap.

Example 3. The method of any of examples 1-2, wherein applying the layout bounding box configuration to the document includes replacing a layout bounding box of at least one of the two or more layouts with an adjusted layout bounding box.

Example 4. The any of examples 1-3, wherein the replacement of a layout bounding box includes combining the two or more layouts into a single layout.

Example 5. The method of any of examples 1-4, further comprising: receiving, by the processor; section information associated with one or more sections of the document, each section including a section bounding box; for at least one layout with an adjusted layout bounding box or a layout bounding box, identifying, by the processor, one or more sections where the respective section bounding box overlaps with the adjusted layout bounding box or the layout bounding box; determining, by the processor, a total area associated with one or more area of overlap, each area of overlap associated with the respective section bounding box overlapping with the adjusted layout bounding box or the layout bounding box; assigning, by the processor, at least one layout to at least one section based on a largest area of overlap associated with the respective section bounding box overlapping with the adjusted layout bounding box or the layout bounding box; and adjusting a layout bounding box for each of the at least one assigned layout.

Example 6. The method of any of examples 1-5, wherein prior to receiving, by a processor coupled to a memory, layout information for two or more layouts of a document, the method further comprises: receiving, by the processor, a document; and dividing, by the processor, the document into one or more individual pages.

Example 7. The method of any of examples 1-6, wherein after dividing the document into one or more individual pages, the method further comprises detecting, by the processor, one or more structures within each of the one or more individual pages.

Example 8. The method of any of examples 1-7, wherein the one or more structures are each a section of the one or more sections.

Example 9. The method any of examples 1-8, further comprising standardizing, by the processor, a dataset associated with the detected one or more structures.

Example 10. The method of any of examples 1-9, wherein the stylometric features include text characteristics and line breaks.

Example 11. A system for resolving conflicts in document layout, the system comprising: a memory storing instructions; and a processor executing the instructions to perform a process including: receiving layout information for two or more layouts of a document, each layout of the two or more layouts having a layout bounding box; identifying one or more areas of overlap between the layout bounding boxes of the two or more layouts, respectively; identifying content associated with each area of overlap, the content include stylometric features; determining, based at least on the layout information for the document, the one or more areas of overlap, and the content associated with each one or more area of overlap, a layout bounding box configuration for the two or more of the layouts of the document; and applying the layout bounding box configuration to the document.

Example 12. The system of example 11, wherein applying the layout bounding box configuration to the document includes replacing the layout bounding box for each layout of the two or more layouts with a respective adjusted layout bounding box, and wherein the adjusted layout bounding boxes for the two or more layouts have no areas of overlap.

Example 13. The system of any of examples 11-12, wherein applying the layout bounding box configuration to the document includes replacing a layout bounding box of at least one of the two or more layouts with an adjusted layout bounding box.

Example 14. The system of any of examples 11-13, wherein the replacement of a layout bounding box includes combining the two or more layouts into a single layout.

Example 15. The system of any of examples 11-14, the processor executing the instructions to further perform: receiving section information associated with one or more sections of the document, each section including one or more section bounding box; for at least one layout with an adjusted layout bounding box or a layout bounding box, identifying one or more sections where the respective section bounding box overlaps with the adjusted layout bounding box or the layout bounding box; determining a total area associated with one or more area of overlap, each area of overlap associated with the respective section bounding box overlapping with the adjusted layout bounding box or the layout bounding box; assigning at least one layout to at least one section based on a largest area of overlap associated with the respective section bounding box overlapping with the adjusted layout bounding box or the layout bounding box; and adjusting a layout bounding box for each of the at least one assigned layout.

Example 16. The system of any of examples 11-15, wherein prior to receiving layout information for two or more layouts of a document, the processor executing the instructions further performs: receiving a document; and dividing said document into one or more individual pages.

Example 17. The system of any of examples 11-16, wherein after dividing said document into one or more individual pages, the processor executing the instructions further performs: detecting one or more structures within each one or more individual pages.

Example 18. The system of any of examples 11-17, wherein said one or more structures are each a section of said one or more sections.

Example 19. The system of any of examples 11-18, the processor executing the instructions to further perform: standardizing a dataset associated with one or more identified structure.

Example 20. A computer-implemented method for processing a document, the method comprising: receiving, by a processor coupled to a memory, a document; determining, by the processor, section information for the document, the section information including one or more sections, each of the one or more sections including a section bounding box; determining, by the processor, layout information for the document, the layout information including one or more layouts, each of the one or more layouts including a layout bounding box; identifying, by the processor, one or more areas of overlap between one or more layout bounding boxes; identifying, by the processor, content associated with each of the one or more areas of overlap; determining, by the processor, based at least on the layout information for the document, the one or more areas of overlap, and the content associated with each of the one or more areas of overlap, a layout bounding box configuration for the one or more of the layouts of the document; applying the layout bounding box configuration to the document, thereby creating one or more adjusted layout bounding boxes; identifying, by the processor, one or more conflicts, each conflict including a bounding box associated with a first layout overlapping with both a first section bounding box and a second section bounding box, the bounding box associated with the first layout including a layout bounding box or an adjusted layout bounding box; determining, by the processor, an area of overlap between the first layout and the first section bounding box and an area of overlap between the first layout and the second section bounding box; assigning, by the processor, the first layout to a section based on the area of overlap between the first layout and the first section bounding box and the area of overlap between the first layout and the second section bounding box; and adjusting, by the processor, the bounding box associated with the first layout based on a section bounding box associated with the assigned section.

What is claimed is:

1. A computer-implemented method for resolving conflicts in document layout, the method comprising:
receiving, by a processor coupled to a memory, layout information for two or more layouts of a document, each layout of the two or more layouts having a layout bounding box;
identifying, by the processor, one or more areas of overlap between the layout bounding boxes of the two or more layouts, respectively;
identifying, by the processor, content associated with each area of overlap, the content including stylometric features;
determining, by the processor and based at least on the layout information for the document, the one or more areas of overlap, and the content associated with each area of overlap, a layout bounding box configuration for the two or more of the layouts of the document; and
applying, by the processor, the layout bounding box configuration to the document.

2. The method of claim 1, wherein applying the layout bounding box configuration to the document includes replacing the layout bounding box for each layout of the two or more layouts with a respective adjusted layout bounding box, and wherein the adjusted layout bounding boxes for the two or more layouts have no areas of overlap.

3. The method of claim 1, wherein applying the layout bounding box configuration to the document includes replacing a layout bounding box of at least one of the two or more layouts with an adjusted layout bounding box.

4. The method of claim 3, wherein the replacement of a layout bounding box includes combining the two or more layouts into a single layout.

5. The method of claim 1, further comprising:
receiving, by the processor; section information associated with one or more sections of the document, each section including a section bounding box;
for at least one layout with an adjusted layout bounding box or a layout bounding box, identifying, by the processor, one or more sections where the respective section bounding box overlaps with the adjusted layout bounding box or the layout bounding box;
determining, by the processor, a total area associated with one or more area of overlap, each area of overlap associated with the respective section bounding box overlapping with the adjusted layout bounding box or the layout bounding box;
assigning, by the processor, at least one layout to at least one section based on a largest area of overlap associated with the respective section bounding box overlapping with the adjusted layout bounding box or the layout bounding box; and
adjusting a layout bounding box for each of the at least one assigned layout.

6. The method of claim 5, wherein prior to receiving, by a processor coupled to a memory, layout information for two or more layouts of a document, the method further comprises:
receiving, by the processor, a document; and
dividing, by the processor, the document into one or more individual pages.

7. The method of claim 6, wherein after dividing the document into one or more individual pages, the method further comprises detecting, by the processor, one or more structures within each of the one or more individual pages.

8. The method of claim 7, wherein the one or more structures are each a section of the one or more sections.

9. The method of claim 8, further comprising standardizing, by the processor, a dataset associated with the detected one or more structures.

10. The method of claim 1, wherein the stylometric features include text characteristics and line breaks.

11. A system for resolving conflicts in document layout, the system comprising:
a memory storing instructions; and
a processor executing the instructions to perform a process including:
receiving layout information for two or more layouts of a document, each layout of the two or more layouts having a layout bounding box;
identifying one or more areas of overlap between the layout bounding boxes of the two or more layouts, respectively;
identifying content associated with each area of overlap, the content include stylometric features;
determining, based at least on the layout information for the document, the one or more areas of overlap, and the content associated with each one or more area of overlap, a layout bounding box configuration for the two or more of the layouts of the document; and
applying the layout bounding box configuration to the document.

12. The system of claim 11, wherein applying the layout bounding box configuration to the document includes replacing the layout bounding box for each layout of the two or more layouts with a respective adjusted layout bounding box, and wherein the adjusted layout bounding boxes for the two or more layouts have no areas of overlap.

13. The system of claim 11, wherein applying the layout bounding box configuration to the document includes replacing a layout bounding box of at least one of the two or more layouts with an adjusted layout bounding box.

14. The system of claim 12, wherein the replacement of a layout bounding box includes combining the two or more layouts into a single layout.

15. The system of claim 11, the processor executing the instructions to further perform:
receiving section information associated with one or more sections of the document, each section including one or more section bounding box;
for at least one layout with an adjusted layout bounding box or a layout bounding box, identifying one or more sections where the respective section bounding box overlaps with the adjusted layout bounding box or the layout bounding box;
determining a total area associated with one or more area of overlap, each area of overlap associated with the respective section bounding box overlapping with the adjusted layout bounding box or the layout bounding box;
assigning at least one layout to at least one section based on a largest area of overlap associated with the respective section bounding box overlapping with the adjusted layout bounding box or the layout bounding box; and
adjusting a layout bounding box for each of the at least one assigned layout.

16. The system of claim 15, wherein prior to receiving layout information for two or more layouts of a document, the processor executing the instructions further performs:
receiving a document; and
dividing said document into one or more individual pages.

17. The system of claim 16, wherein after dividing said document into one or more individual pages, the processor executing the instructions further performs: detecting one or more structures within each one or more individual pages.

18. The system of claim 17, wherein said one or more structures are each a section of said one or more sections.

19. The system of claim 18, the processor executing the instructions to further perform:
standardizing a dataset associated with one or more identified structure.

20. A computer-implemented method for processing a document, the method comprising:
receiving, by a processor coupled to a memory, a document;
determining, by the processor, section information for the document, the section information including one or more sections, each of the one or more sections including a section bounding box;
determining, by the processor, layout information for the document, the layout information including one or more layouts, each of the one or more layouts including a layout bounding box;
identifying, by the processor, one or more areas of overlap between one or more layout bounding boxes;
identifying, by the processor, content associated with each of the one or more areas of overlap;
determining, by the processor, based at least on the layout information for the document, the one or more areas of overlap, and the content associated with each of the one or more areas of overlap, a layout bounding box configuration for the one or more of the layouts of the document;
applying the layout bounding box configuration to the document, thereby creating one or more adjusted layout bounding boxes;
identifying, by the processor, one or more conflicts, each conflict including a bounding box associated with a first layout overlapping with both a first section bounding box and a second section bounding box, the bounding box associated with the first layout including a layout bounding box or an adjusted layout bounding box;
determining, by the processor, an area of overlap between the first layout and the first section bounding box and an area of overlap between the first layout and the second section bounding box;
assigning, by the processor, the first layout to a section based on the area of overlap between the first layout and the first section bounding box and the area of overlap between the first layout and the second section bounding box; and
adjusting, by the processor, the bounding box associated with the first layout based on a section bounding box associated with the assigned section.
